(19) United States
(12) Patent Application Publication
(10) Pub. No.: US 2015/0218346 A1
(43) Pub. Date: Aug. 6, 2015

(54) PLASTIC PART FOR A RAILWAY VEHICLE

(71) Applicant: DSM IP Assets B.V., Heerlen (NL)

(72) Inventors: Rui Zhang, Echt (NL); Josien Krijgsman, Echt (NL)

(21) Appl. No.: 14/367,474

(22) PCT Filed: Dec. 11, 2012
(86) PCT No.: PCT/EP2012/075078

§ 371 Date: Jun. 20, 2014

(51) Int. Cl. C08K 7/14; C08K 5/5313; C08K 5/3492

(52) U.S. Cl. CPC C08K 7/14; C08K 5/34922; C08K 5/5313

(57) ABSTRACT

The invention relates to a railway vehicle comprising an electrical or electronic system comprising a plastic part, characterized in that the plastic part is made from a halogen free flame retardant polymer composition comprising a thermoplastic polymer, glass fibers and melam. The invention relates to a plastic part as described here above, or an electrical or electronic product or system comprising said plastic part, labeled with a classification according to EN45545 or according to NFF 16-101.

The present invention relates to a plastic part for a railway vehicle, as well to a railway vehicle comprising said plastic part. The invention in particular relates to a plastic part used in an electrical or electronic system in a railway vehicle.

In the field of public transportation, reduction or even better complete elimination of the risk of exposure of the public to fire hazards is a topic that has everlasting attention, and requirements are ever increasing. The first and main objective of the measures and requirements is to protect passengers and staff in railway vehicles in the event of a fire on board. This is separate from measures which ensure the preservation of the vehicles in the events of a fire.

As the risks involved depend on the construction, the components used and the specific uses of the railways vehicles, test methods as well as performance level requirements are tailored for all kinds of different situations. In Europe, USA, China and other countries, there are many standard and test method of fire testing for railway components because of the difference of background of history and experience on fire proof measures. The European Standard for Fire Protection of Railway Vehicles is EN 45545/Pr CEN TS 45545, latest issue 2009. Part 2, i.e. EN 45545-2/Pr CEN TS 45545-2 describes the requirements for fire behavior of materials and components.

The risks of fire involved may result from accident or arson typical ignition models involving newspaper, matches, cigarettes and gas lighters, which shall be taken into consideration in any position freely accessible to passengers and staff. These accidents can also lead to larger ignition models e.g. passenger clothes or passenger luggage. Fire resulting from technical defects ignition models, comparable to electric arcs or abnormal temperatures and effects of any flammable gases or flammable liquids which may be present shall also be taken into account. EN 45545-2/Pr CEN TS 45545-2 describes in detail the parameters for evaluation of reaction to fire and spread of flame for specific products, including plastic products, in respect to ignitability, heat release, smoke and toxicity. Next to this pan-European norm, there are additional national norms, which differ per country, such as DIN norms for Germany, BS norms for Great Britain, and NFF norms for France. The French norm NFF 16-101 requires low “I” rating, which is a combination of a high GWIT and a high oxygen index, as well as a low “F” rating, which a combination low smoke density and a low gas toxicity of the combustion gases.

Plastic parts, in particular those used in electrical or electronic systems, can also provide fire risks. Typically, the polymer components used in these products, in particular thermoplastic polymers such as thermoplastic polyesters and thermoplastic polyamides which are widely used in such applications, are not fire resistant themselves and have to be combined with flame retardants to make the plastic parts made from these materials flame retardant. Many of these products have a flame retardancy level complying with UL standards for the electrical and electronic industry. A problem that has been encountered by the present inventors is that these flame retardant thermoplastic materials and the plastic parts made thereof, do not comply with all the requirements of EN 45545-2/Pr CEN TS 45545-2. In particular the smoke density and toxicity requirements are difficult to comply with, let alone that these materials and parts have to comply with all requirements of the DIN, BS and NFF norms. In particular for vehicles designed or equipped to run on underground sections, tunnels and/or elevated structures, without side evacuation available and where there are no stations or emergency stations that offer a place of ultimate safety to passengers, reachable within a short running time, which are classified for the hazardous level (HL) HL3, the requirements for electronic and electrical components as defined in requirement set R24 and even more so in requirement set R23, are very severe in terms of the combination of oxygen index (OI), maximum smoke density (Ds max) and toxicity index (C.I.T_{NLP}).

The aim of the present invention has been to provide a plastic part for a railway vehicle, as well as a railway vehicle comprising said plastic part, wherein the plastic part has a UL-rating for use in electrical & electronic systems, and complies with the HL3 requirements of EN 45545-2/Pr CEN TS 45545-2.

This aim has been achieved with the railway vehicle according to the invention, wherein the plastic part is made from a halogen free flame retardant polymer composition comprising a thermoplastic polymer, glass fibers and melam.

Melam is a condensation of melamine and acts as a flame retardant. Surprisingly, it has been found that the plastic part made from the said halogen free flame retardant polymer composition comprising the thermoplastic polymer, glass fibers and melam as the flame retardant not only provides good flame retardancy properties, but also a high oxygen index as well as low smoke density and a low toxicity index. This in contrast to plastic part comprising as the main flame retardant component either a halogen containing flame retardant, a halogen free phosphorous based flame retardants or another halogen free nitrogen based flame retardant, as these do not comply with all the requirements and suffer in one or more of these aspects.

The thermoplastic polymer in the polymer composition used for the plastic part may comprise, for example, a thermoplastic polyamide polymer or a thermoplastic polyester polymer, and suitably consists for at least 50 wt. % of the thermoplastic polyamide polymer and/or the thermoplastic polyester polymer, relative to the total weight of the thermoplastic polymer in the composition.

For processing purposes of the plastic parts in electrical and electronic components, the plastic part comprises a semi-crystalline thermoplastic polymer, more particular a semi-crystalline thermoplastic polyester and/or a semi-crystalline thermoplastic polyamide polymer, having a melting temperature (Tm) of at least 250° C.

With the melting temperature is herein understood the melting enthalpy temperature measured by the method according to ISO-11357-3.2, 2009. The measurement is executed on pre-dried samples, in an N₂ atmosphere with heating and cooling rate of 10° C./min, wherein Tm is measured and calculated for the second heating curve.

The components comprised by the polymer composition may be present in an amount varying over a wide range, depending on the specific use of the plastic part and the requirements linked to that specific use.

Suitably, the glass fibers are present in an amount in the range of 10-60 wt. %, more particular 15-50 wt %, relative to the total weight of the plastic composition. Useful practical examples are, for example, amounts around 20 wt. %, as well as around 30 wt. %, and around 40 wt. % for higher modulus and mechanical strength. Above 50 wt. % the mechanical properties will suffer as the material will be very brittle, and below 15 wt. % will result in compromising the flame retardancy.

The amount of melam in the composition depends on the requirements for the flame retardancy and oxygen index. Preferably, the amount is in the range of 15-35 wt %, relative to the total weight of the plastic composition. Useful practical examples are, for example, amounts around 20.wt. %, as well as around 30 wt. % for a higher flame retardancy level.

The composition may further comprise other components. As such other components the composition may comprise, for example, flame retardants other than melam. Such other flame retardant can be, for example, a phosphorous flame retardant and/or nitrogen based flame retardant. Such other flame retardant could be used to further enhance the flame retardancy. In view of the present invention, in case another flame retardant is used next to melam, the amount thereof should be kept limited in order not to jeopardize the effect of the present invention. With melam as the main or only flame retardant in the polymer composition, the amount of other flame retardants shall be less than that of melam, and certainly below 15 wt. %, relative to the total weight of the composition. Preferably, the amount of other flame retardants is in the range of 0-10 wt. %, or even better 0-7.5 wt. %, relative to the total weight of the composition.

Suitably, the other flame retardant comprises a phosphorous based flame retardant selected from metal phosphinates and metal diphosphinates, and/or a nitrogen based flame retardant selected from melamine, melamine cyanurate, melem and melon, and/or phosphorous and nitrogen based flame retardant selected from polyphosphate salts of ammonium, melamine, melam, melem and melon, and phosphinate and diphosphinates salts of ammonium, melamine, melam, melem and melon. Melem and melon are, like melam, condensation products of melamine. A suitable example of a phosphorous flame retardant is aluminum dilakyl(di)phosphinate, more particular aluminum diethyl(di)phosphinate.
a. As an example of the present invention, the composition used for the plastic part comprises a thermoplastic polyamide polymer and/or a thermoplastic polyester polymer;
b. 15-50 wt % glass fibers;
c. 15-35 wt % melam; and
d. 0-15 wt. % of a phosphorous flame retardant and/or a nitrogen based flame retardant.

Herein, the wt. % are relative to the total weight of the composition.

The polymer composition may further comprise other components, such as auxiliary additives used in thermoplastic polymer compositions for electric and electronic components. Such additives can include flame retardant synergists, inorganic fillers, inorganic fibers other than glass fibers, pigments, processing aids, stabilizers, etc.

The inorganic fillers, as they are typically inert with regard to flammability and toxic fumes, may be present in an amount varying over a wide range, for example from 1 to 40 wt. %, suitably 5-25 wt. %,

Additives other than the thermoplastic polymer, the glass fibers, melam and other flame retardants, and inorganic fillers, are typically used to enhance specific properties of the composition and are generally used in relative low amounts each. The total amount of such additives is suitably in the range of 0-20 wt. %, more particular 0.5-10 wt. %, relative to the total weight of the composition.

As an example of the present invention, the composition used for the plastic part comprises
a. 30-70 wt. % of a thermoplastic polymer;
b. 15-50 wt % glass fibers;
c. 15-35 wt % melam; and
d. 0-15 wt. % of a phosphorous flame retardant and/or a nitrogen based flame retardant; and
e. 0-40 wt. % of at least one component selected from the group consisting of inorganic fillers, inorganic fibers other than glass fibers, pigments, processing aids, stabilizers.

Herein, the wt. % are relative to the total weight of the composition. The amounts of the different types of components refer to the total amount of said types of components, not to individual components thereof. For instance if both a thermoplastic polyamide polymer and a thermoplastic polyester polymer, the amount of component (a) refers to the total amount of the thermoplastic polyamide polymer and the thermoplastic polyester polymer. If two phosphorous flame retardants are present, the amount of component (d) refers to the total amount of these two phosphorous flame retardants. Analogously, if the composition comprises an inorganic filler, two pigments and a stabilizer, the amount of component (e) refers to the total amount of these components.

In a particular embodiment of the present invention, the polymer composition of which the plastic part is made, consists of the components (a)-(e) in the amounts indicated above. This means that the sum of the amounts of the components (a)-(e) is equal to 100 wt. %.

The plastic part in the present invention made of the polymer composition as described above, may have different wall thicknesses at different locations in the plastic part. Preferably, the plastic part has a wall thickness of at most 3 mm, more preferably at most 2 mm, and still more preferably at most 1 mm. With a lower maximum wall thickness, better ratings are achieved as it appears to be easier to comply with the more stringent requirement levels of EN45545. On the other hand, the plastic part may well have a thickness above 3 mm, or one or more locations with a thickness above 3 mm, as such a part will still comply with less demanding requirement levels of EN45545 suitable for less critical applications, meanwhile still performing better than corresponding plastic parts made from other flame retardant materials

In the railway vehicle according to the present invention, the plastic part can be part of an electrical or electronic system, but is not necessarily limited thereto. Suitably, the plastic part is a surge arrester, an isolator, a switch, a circuit breaker, a current or voltage transformer, a contactor, a choke for supply line filtering, a bobbin for a coil, e.g. for air cooled transformers, a motorstarter, a residual current breaker, a busbar component, or a connector, or a part of any of these.

In a preferred embodiment, the plastic part embraced by the present invention is used in products classified as E6, E7A, E7B, E8A or E8B according to product definition according to EN 45545.

In another preferred embodiment, the plastic part is used in a non-listed product falling in the category R23 or R24 for the material requirements according to EN 45545.

More particular, the so classified products are used in vehicles in Operation Category 3, which require a performance level HL3. This performance level is suitably achieved by using a plastic part with a wall thickness of at most 3 mm and with a melam content in the range of 15-30 wt. %, relative to the total weight of the composition.

Suitably, the railway vehicle according to the present invention is selected from the group consisting of locomotives, multiple unit combinations, coaches, light rail vehicles, underground vehicles, trams, trolley buses and magnetic levitation vehicles. Trolley buses are included as these also have an electrical guidance system or electrical rail and on board electrical equipment.

The present invention also relates to the use of a plastic part as described herein above in an electrical or electronic system in a railway vehicle.

The invention further relates to a plastic part as described herein above, or an electrical or electronic product or system comprising said plastic part, labeled with a product classification according to EN45545. The labeling may be on the product itself, the packaging or the brochure or any other format of publicity. The packaging so labeled may bear the reference to the product and/or may comprise the product. The brochure or any other format of publicity shall bear or comprise the reference to the product. With the product is herein understood the plastic part, respectively the electrical or electronic product or system comprising said plastic part.

In a preferred embodiment, the plastic part, the electrical or electronic product or system comprising said plastic part is labeled with a material category R23 or R24 according to EN45545.

The plastic parts used in the present invention not only have a high oxygen index in combination with a low smoke density and a low gas toxicity of the combustion gases, but also a high GWIT, such that allows for a low I/F rating according to the French norm NFF 16-101. More particular, with the plastic parts used in the present invention, it is possible to achieve a classification I2F2 according to NFF 16-101. Therefore the present invention also relates to a plastic part made from a composition as described above, or an electrical or electronic product or system comprising said plastic part, labeled with a classification I2F2 according to NFF 16-101.

The invention is further illustrated with the following examples and comparative experiments.

### MATERIALS

Thermoplastic polymer compositions comprising polyamide polymer, glass fiber reinforcement and different flame retardants were injection molded to make test samples and tested according to EN 45545-2/Pr CEN TS 45545-2 2009 and NFF 16-101. The compositions and test results have been listed in table 1.

The components used in the compositions were the following:
Polyamide: PA46=Polyamide 46 (Tm 295° C.) , PA-6=Polyamide-6 (Tm 220° C.), PA-66=Polyamide-66 (Tm 265° C.);
GF glass fibres, standard grade for polyamides;
FR-1 melam;
FR-II Exolit OP1230: phosphinate flame retardant ex Clariant;
FR-III melamine cyanurate;
FR-IV brominated polystyrene with an antimony trioxide as synergist
FR-V Exolit OP1311: phosphinate flame retardant ex Clariant.

### Test Methods

The Toxicity C.I.T., Density of Smoke (DSmax) and Oxygen Index (%) were measured in line with the methods prescribed by EN45545. The HL3 rating was done according the EN45545 guidelines for materials and components.

The I/F rating and the underlying measurements for GWIT, Oxygen Index (%), and the smoke density and gas toxicity of the combustion gases was done according to the French norm NFF 16-101.

As can be seen in Table 1, the results for the example according to the present invention comply with the requirement set R23 and even with the requirement set R24 of EN 45545/Pr CEN TS 45545, whereas the comparative examples do neither comply with R24 nor with R23. Furthermore, example according to the present invention qualifies with the I2/F2 rating for the French norm NFF 16-101, whereas the comparative examples are higher in the I rating or the F rating, or even both.

TABLE 1
part A. Compositions and UL-94-V test results for Example I
and Comparative Experiments A-F

| Components | | | | | | | |
|---|---|---|---|---|---|---|---|
| (amounts in | | | | | | | |
| wt. %) | EX-I | CE-A | CE-B | CE-C | CE-D | CE-E | CE-F |
| PA (type) | PA46/PA6 | PA6 | PA6 | PA46 | PA6 | PA66 | PA6 |
| | Blend | | | | | | |
| PA (amount) | 39.5 | 58.5 | 55.4 | 49.5 | 49.5 | 49.5 | 69.5 |
| GF | 30 | 30 | 30 | 30 | 30 | 30 | 30 |
| FR-1 | 25 | — | — | — | — | — | — |
| FR-II | 5 | — | — | — | | | — |
| FR-III | — | 11 | — | — | — | — | — |
| FR-IV | — | — | 14.1 | 20 | — | — | — |
| FR-V | — | — | — | — | 20 | 20 | — |
| Aux. Additives | 0.5 | 0.5 | 0.5 | 0.5 | 0.5 | 0.5 | 0.5 |
| UL -94 rating | V0 | V2 | V0 | V0 | V0 | V0 | HB |
| (0.75 mm) | | | | | | | |

part B: EN45545/HL3 and NFF 16-101 test results for Example I and
Comparative Experiments (CE) A-F^{(a)}

| Tests | Required | EX-1 | CE-A | CE-B | CE-C | CE-D | CE- E | CE-F |
|---|---|---|---|---|---|---|---|---|
| EN45545/HL3 | | | | | | | | |
| Toxicity C.I.T. | <0.75 | 0.58 | | 0.702 | | 0.388 | | ++^{(c)} |
| Density of Smoke | <150 | 124 (0.75) | | 1320 (1.5) | high | 322 (1.5) | | ++^{(c)} |
| (DSmax) | | 149 (3.0) | | | | | | |
| Oxygen Index (%) | >32% | 39.6 | 26.2 | | 46.7 | | | 20-28 |
| HL3 Rating^{(b)} | R23/R24 | Pass | NC | NC | NC | NC | | NC |
| NFF 16-101 | | | | | | | | |
| GWIT | >850 (I2) | >850 | <850 | | >850 | <850 | <850 | <<850 |
| Oxygen Index (%) | >32% (I2) | 39.6 | 26.2 | | 46.7 (2 | | 33.7 (1.5) | 20-28 |
| Density and | <40 (F2) | 38.8 (0.75) | <40 | | 62.5 (2) | | 60.5 (1.5) | 20-40 |
| toxicity | | 36.3 (3.0) | | | | | | |
| I/F rating | I2/F2 | I2/F2 | I4/F2 | | I2/F3 | | I3/F3 | I4/F2 |

^{(a)}For tests where the thickness of the tested sample is relevant, the thickness has been put in between brackets after the measured result.
^{(b)}NC = non-classified;
^{(c)}++ = very good

1. Railway vehicle comprising an electrical or electronic system comprising a plastic part, characterized in that the plastic part is made from a halogen free flame retardant polymer composition comprising a thermoplastic polymer, glass fibres and melam.

2. Railway vehicle according to claim 1, wherein the thermoplastic polymer comprises a thermoplastic polyamide polymer and/or a thermoplastic polyester polymer.

3. Railway vehicle according to claim 1, wherein the thermoplastic polymer comprises a semi-crystalline polymer having a melting temperature of at least 250° C.

4. Railway vehicle according to claim 1, wherein the composition comprises
a. a thermoplastic polyamide polymer and/or a thermoplastic polyester polymer;
b. 15-50 wt % glass fibres;
c. 15-35 wt % melam; and
d. 0-15 wt. % of a phosphorous flame retardant and/or a nitrogen based flame retardant.

5. Railway vehicle according to claim 1, wherein the plastic part is a surge arrester, an isolator, a switch, a circuit breaker, a current or voltage transformer, a contactor, a choke for supply line filtering, a bobbin with a coil, a motor starter, a residual current breaker, a busbar component, or a connector, or a part of any of these.

6. Railway vehicle according to claim 1, wherein the plastic part is used in products classified as E6, E7A, E7B, E8A or E8B according to EN 45545.

7. Railway vehicle according to claim 1, wherein the plastic part is used in a product falling in the category R23 or R24 for the material requirements of non-listed products according to EN 45545.

8. Railway vehicle according to claim 1, wherein the railway vehicle is selected from the group consisting of locomotives, multiple unit combinations, coaches, light rail vehicles, underground vehicles, trams, trolley buses and magnetic levitation vehicles. Use of a plastic part as described in claim 1 in an electrical or electronic system in a railway vehicle.

9. Plastic part for use in a an electrical or electronic system in a railway vehicle, wherein the plastic part is made from a halogen free flame retardant polymer composition comprising
a. a thermoplastic polyamide polymer and/or a thermoplastic polyester polymer;
b. 15-50 wt % glass fibres;
c. 15-35 wt % melam; and
d. 0-15 wt. % of a phosphorous flame retardant and/or a nitrogen based flame retardant.

10. Plastic part as described in claim 1, labeled with a product classification E6, E7A, E7B, E8A or E8B according to EN45545 and/or a material category R23 or R24 according to EN45545.

11. An electrical or electronic product or system comprising a plastic part as described in claim 1, labeled with a product classification E6, E7A, E7B, E8A or E8B according to EN45545 and/or a material category R23 or R24 according to EN45545.

12. Plastic part as described in claim 1, or an electrical or electronic product or system comprising said plastic part, labeled with a classification I2F2 according to NFF 16-101.
